(19) United States
(12) Patent Application Publication
(10) Pub. No.: US 2010/0170546 A1
(43) Pub. Date: Jul. 8, 2010

(54) DEVICE FOR BALANCE AND BODY ORIENTATION SUPPORT

(75) Inventors: Dejan Popovic, Belgrade (RS); Aleksander Veg, Belgrade (RS)

Correspondence Address: CANTOR COLBURN, LLP, 20 Church Street, 22nd Floor, Hartford, CT, 06103, US

(73) Assignee: FUNDACION FATRONIK, San Sebastian (ES)

(21) Appl. No.: 12/601,969

(22) PCT Filed: May 28, 2008
(86) PCT No.: PCT/EP08/56537

§ 371 Date: Mar. 3, 2010

(30) Foreign Application Priority Data
May 28, 2007 (RS) 2007/0229

(51) Int. Cl. A61H 3/04

(52) U.S. Cl. 135/67

(57) ABSTRACT

Device for balance and body orientation support configured to control the body position of individuals with sensory-motor disability that prevents them from normal standing and walking, that comprises a top frame (6) linked to a bottom frame (15) by telescopic rods (8, 9), wherein the bottom frame (15) comprises wheels and the top frame (6) is linked by means of suspension elements to a lumbar belt, thus being the stiffness of the device configured to be regulated according to the disability level of the individual, and thus providing reduction of the loading of legs by partial support of the body weight; hence allow therapy of the walking in neurorehabilitation, but also exercise after surgical interventions. The device can be adjusted to fit the size of the potential individual with the simple tools.

### TECHNICAL FIELD OF THE INVENTION

The invention relates to a device for balance and body orientation support, solving the technical problem of how to provide control of balance and body orientation during hands free standing and walking to individuals with compromised physical abilities caused by injury or disease of the central nervous system or other reasons, e.g., age related disability, by a device that is modular and adaptive in size to the individual and her/his needs.

### BACKGROUND OF THE INVENTION

One possible method of solving the problem of providing the balance and body orientation during hands free standing and walking is the use of a robotic mechanism where the robot applies controlled movements to the body and extremities. The available commercial systems use two methods: 1) control of the feet movement of impaired individuals that mimics movement characteristic for the feet movements of the individuals with no orthopedic, neurological or age related disorders in parallel to body support by a harness that is adjustable to partially compensate the gravity force (Advanced Gait Trainer, RehaStim, Berlin, Germany), 2) control of leg segments movement in impaired individuals along the trajectories that are alike trajectories characteristic for movement of individuals with no orthopedic, neurological or age related disorders in parallel to body support by a harness that is adjustable to partially compensate the gravity force and use of powered treadmill (Locomat, Hokoma, Switzerland). Similar devices are in development in other research centres but using principles described above, e.g., Altacro, Free University of Brussels, Belgium).

They are proven to be successful in restoration of walking capabilities, reducing functional impairment, as well as increasing of mobility of stroke survivors and spasticity patients. Due to the treadmill configuration, this type of equipment is limited to training of straight ground level walking, and mobility in daily situations cannot be supported.

The alternative to stationary devices are rollators and walkers of different kinds that in most cases do not allow hands free standing and walking. The shortened description of the representative rollators and walkers follows:

Standard walkers: a standard walker may include wheels and glide-type brakes. A wheeled walker is one with 2, 3 or 4 wheels. The wheels may be fixed or swivel. It may be fixed height or adjustable height. It may or may not include glide-type brakes or equivalent. A glide-type brake consists of a spring mechanism, or equivalent, which raises the leg post of the walker off the ground when the member is not pushing down on the frame.

Pediatric walkers and crawlers: specially adapted strollers may be considered medically necessary when they are used in place of a wheelchair for children.

Heavy-duty walker: a heavy-duty walker is one that is labeled as capable of supporting members who weigh more that 300 pounds. It may be fixed height or adjustable height. It may be rigid or folding. A heavy-duty walker is considered medically necessary for members who meet medical necessary criteria for a standard walker and weighing more than 300 pounds. A heavy-duty walker may include wheels and glide-type brakes. A wheeled walker is one with 2, 3 or 4 wheels. The wheels may be fixed or swivel. It may be fixed height or adjustable height. It may or may not include glide-type brakes, or equivalent. A glide-type brake consists of a spring mechanism, or equivalent, which raises the leg post of the walker off the ground when the member is not pushing down on the frame.

Heavy duty, multiple braking system, variable wheel resistance walker: a heavy duty, multiple braking system, variable wheel resistance walker is considered medically necessary for members who meet medical criteria for a standard walker and who are unable to use a standard walker due to a severe neurological disorder or other condition causing the restricted use of one hand. Obesity, by itself, is not considered a medically necessary indication for this walker.

Heavy duty, multiple braking system, and variable wheel resistance walker is a 4-wheeled, adjustable height, folding-walker that has all of the following characteristics. This support is capable of supporting individuals who weigh greater than 350 pounds, and hand operated brakes that cause the wheels to lock when then the hand levers are released, and the hand brakes can be set so that either of both can lock the wheels, and the pressure required to operate each hand brake is individually adjustable, and there is an additional braking mechanism on the front crossbar, and at least two wheels have brakes that can be independently set through tension adjustability to give varying resistance.

Walker with enclosed frame: a walker with enclosed frame is a folding wheeled walker that has a frame that completely surrounds the member and an attached seat in the back.

A state of the art walker with passive control is the NF-walker (Norsk Funktion, Norway). It allows children with balance problems to stand and to walk and provides some basic coordination of the by two elastic bands. Prerequisite for using the NF-walker is a minimum of active functionality of the lower limbs. Disadvantages are the difficulties to maneuver in small rooms and the unnatural gait patterns.

Finally, the most sophisticated solutions, still in the domain of ideas and prototypes suggest the use of humanoid robots, e.g., HAL5 robot suit (University of Tsukuba, Japan). HAL5 can help to walk or lift heavy objects and uses bioelectric sensors attached to the skin in order to monitor the signals transmitted from the brain to the particular muscle. This nerve signal generates an electric current on the skin surface which is translated into signals for electric motors at hip and knee joints. This procedure is definitely controversial at this time. Due to that electronic information processing, the exoskeleton actuators respond faster than the human's muscles. The disadvantage of this kind of robots is the limitation to amplifying the intention of users. In order to help humans with lack of balance, such exoskeletons have to be integrated with models of walking. Their great potential in rehabilitation is the ability to give assistance to both pairs of limbs and single weaker limbs.

The patents related to the development of the new idea presented in this application are:

U.S. Pat. No. 7,111,856 (Graham, Sep. 26, 2006) discloses a bipedal motion assisting method and apparatus that comprises a mobile support system having a central region that allows the legs to move in an unobstructed manner and providing an upper body support assembly where the weight is distributed between the elbow region and hand region of the individual for a desirable weight distribution for assisted bipedal motion such as walking or running.

U.S. Pat. No. 7,017,525 (Leach, Mar. 28, 2006) discloses a multipurpose harness assembly for use in assisting a muscular-incapacitated person that comprises a multipurpose harness assembly for lifting and supporting a person characteristically known to have little or no control over muscular function insofar to support oneself for purposes of standing erect or walking, the harness assembly comprising a pair of wearable harness, one of which is worn by an assisting person and a second harness being worn by a muscular-incapacitated person. Each harness comprises left- and right-handed shoulder straps tighteningly secured to the wearer by a waist belt and an upper torso strap, both of which are slidably fitted through a plurality of strap guides selectively mounted to each of the shoulder straps and tighteningly held in place by a waist buckle and an upper torso buckle, respectively, and at least one horizontal support member fixedly attached to the shoulder straps to maintain a parallel relationship to one another and minimize the occurrence of slippage from the wearer's shoulder. A pair of supporting tethers each having a first end fixedly attached to the shoulder strap of the harness worn by the assisting person and a second end releasably connected to the harness worn by the muscular-incapacitated person effectively serve as means to connect the two harnesses together for purposes of engaging in the activities of lifting the muscular-incapacitated person from an at-rest position and supporting and guiding the muscular-incapacitated person as he or she proceeds to walk, sit or stand erect in a stationary position.

U.S. Pat. No. 6,974,142 (Shikinami, et al., Dec. 13, 2005) discloses a vehicle to assist walking. A vehicle which has a function to help a person walk and a function that a helper can move a person, comprises a frame extending around a body of a user for supporting the body of the user when the user walks using the vehicle, wheels mounted on the frame, and a seat plate which can project from the generally lateral side of the user into an area where the legs of the walking user move. The seat plate is withdrawn from the area where the legs of the walking user move when the user walks using the vehicle.

U.S. Pat. No. 6,755,203 (Roeglin, Jun. 29, 2004) discloses a two-legged walker useful as a mobility assisting device for those temporarily or permanently disabled or infirm which is supported by the user's hand, not under the user's arms, is both lockably rigid and jointed to mimic and support the walking function of the user, is capable of multiple modes of use, is adjustable in its dimensions to fit the user's height and needs, and is adjustable to support use on stairs.

U.S. Pat. No. 6,659,478 (Hallgrimsson, et al., Dec. 9, 2003) discloses a combination walker and transport chair that comprises a wheeled walker convertible to a transport chair. The walker has a strap-type backrest that is pivotally attached to the upper end of the handlebars. The backrest can be placed in a forward position when the apparatus is used as a walker and the user wishes to rest in a rearward facing sitting position and in a rearward position when the apparatus is used as a transport chair and the user sits in a forward facing position and is propelled by a care-giver. A novel braking system locates the brake actuating linkage inside the leg and handlebar members and provides accommodates extension height adjustment of the handlebars. A brake lever system providing a linear pull non-cable brake actuation is also disclosed.

U.S. Pat. No. 6,325,023 (Elnatan, Dec. 4, 2001) discloses a method and an apparatus for assisting a child to walk. A method and apparatus for enabling a larger person to assist a smaller disabled person to learn to stand and to walk while keeping the hands of both persons free for other tasks. The apparatus comprises two body harnesses and a foot harness. One of the body harnesses is worn by the larger person and the second body harness is worn by the smaller person. The foot harness is worn by both persons. The first and second harnesses are connected to each other to enable the smaller person to have substantial freedom of movement while the larger person supports and assists the smaller person to walk. A apparatus for enabling a larger person to assist a smaller disabled person to learn to stand and walk while keeping the hands of both persons free for other tasks. The apparatus comprises a harness which is worn by the larger person. The harness is connected to the smaller person so that the smaller person has substantial freedom of movement while the larger person assists the smaller person to walk.

U.S. Pat. No. 5,794,639 (Einbinder, Aug. 18, 1998) discloses an adjustably controllable walker. A controller for wheeled vehicles includes a mechanism which selectively shifts the vehicle between a mobile and a stable state. The vehicle may be a walker for easing an operator's efforts in walking and includes a selectively actuable stabilizer which fixes the position of the walker or releases it for rolling motion, thus providing a stable state or a mobile state, respectively. An actuator such as a button, pressure sensor, or lever, electrically and/or mechanically actuates a stabilizer brake mechanism to engage or release the brake and thereby allow the walker's mobility to be controlled when the actuator operates the brake to stabilize or to slow the motion of the walker. Preferably, lift applied to the vehicle itself releases the brake and allows mobility. The actuator may control an electrically actuated braking mechanism, in response to a sensor such as a strain gauge that may be adjusted to the needs of the patient; alternatively, lifters may provide to act in response to the lifting force.

U.S. Pat. No. 5,524,720 ((Lathrop, Jun. 11, 1996) discloses a powered walker having integrated parallel bars that provides a stable and mobile walking frame for those who must pull on objects is adapted to move forward according to a user's needs. The user controls movement of the walker by depressing a switch; the speed at which the device moves is also user controlled.

U.S. Pat. No. 5,224,717 (Lowen, Jul. 6, 1993) discloses a walking aid device which allows the user to retain a full upright position while providing continuous support of a portion of the user's body weight and allow the user to easily maneuver the device. The device has wheels which support two side sections providing upper portions at approximately elbow height. A brace member joins the side sections and spaces the upper portions thereof at a transverse distance slightly greater than the person's body width. Armrests are attached to the upper portions and extend in the fore and aft direction so as to provide a rear elbow engaging portion with a forearm engaging portion extending forwardly from the elbow engaging portion and having an upright hand grip at the forward end thereof. A transverse rib-rest is provided between the arm-rest means adjacent the rear of the armrest. The brace member between the side sections may be located between rear legs of the side section and is located near the upper portion to allow free leg room when the user is positioned against the rib-rest behind the device. The area defined between the side sections and in front of the rib-rest may be entirely open to allow the user to enter the space between the side sections from what would normally be the front of the device.

U.S. Pat. No. 5,133,377 (Truxillo, Jul. 28, 1992) discloses an invalid walker. An improvement in walkers including a set of specially designed, spring biased, retractable casters on at least the four corner legs of the walker apparatus to assist the user in moving the walker apparatus from one point to another. The walker further includes an adjustable seating system situated to the rear of the user for ease of utilization without the need to turn around when seating oneself. Additionally, an accessory food tray sub-system is provided. The walker is designed to provide an effective means for invalids, the elderly, and the like to comfortably, easily and without fear move about an area, while also having a seat and tray readily available so that the user can rest and even comfortably sit and eat or engage in other activities, thereby relieving the user of the necessity of having to manipulate furniture in sitting and getting up, an often painful process for the infirm.

U.S. Pat. No. 4,987,912 (Taylor, Jan. 29, 1991) discloses a walker assembly having stabilizer means. Walker having four legged frame defining front and a pair of sides, each having a cross-bar. The invention provides a stabilizing bar secured to the front cross-bar to extend angularly forwardly at an acute angle to provide a non-tippable structure particularly while the user is using the walker as support during the act of assuming a sitting position or rising therefrom. The stabilizer bar can be adjusted as to length and, can be pivotally mounted so that it can be swingably maneuvered to be inactive when the walker is not being used.

U.S. Pat. No. 4,869,279 (Hedges, Sep. 26, 1989) discloses an invalid walker comprising right and left side frame members in the form of an inverted Y-shape, each frame member containing a vertical leg, a side leg attached downwardly and rearwardly from the vertical leg and a horizontal brace connecting the vertical leg and side leg, a front horizontal member connecting the right and left side frame members, and handgrip support attached to the upper end of each vertical leg. Stair climbing convenience is provided by a forward extension of the horizontal brace and a restraint strap between the handgrip supports provides an optional safety feature.

U.S. Pat. No. 4,621,804 (Mueller, Nov. 11, 1986) discloses a therapeutic roller/walker. A therapeutic walker bas features which permit its use by persons with varying degrees of disability and is capable of adaptation to be used in different ways as the level of disability diminishes. A walker frame extends substantially around three sides of the region occupied by person using the walker and a removable closure bar is attached across the frame on its open side. An elongated crotch-cradling panel of flexible material is removably attached between the closure bar and the frame on the opposite side of the walker. The person using the walker straddles the crotch-cradling panel which is adjustable in length for persons of different sizes. The legs of the walker are adjustable in height and terminate in removable or retractable casters. A person using the walker can either sit down on the seat or stand up in the walker, with appropriate adjustments being made in the length of the legs. In more severe cases of disability, the caster wheels are employed and the seat acts as a safety feature if the person using the walker should stumble or fall, since it will catch the person and prevent or minimize injury. For persons with less disability, the seat may be removed and the casters may be removed or retracted; so that the walker can be used in a conventional manner.

### SUMMARY OF THE INVENTION

The present invention relates to a device for balance and body orientation support to be used for control of balance and orientation of the body in humans with decreased ability to stand and walk hands free due to partial damage of the central nervous system or impaired neuromuscular or musculoskeletal system by interfacing the individual with an ergonomic specially reinforced lumbar belt with three connecting points articulated via suspension elements or suspensors, e.g. consisting of damped springs mechanisms, to an open top frame, where the top frame is above the center of mass connected or linked with an open bottom frame that interfaces the ground by a plurality of wheels that allow motion of the platform defined by both frames and wheels in horizontal plane, where the connection between the bottom and top frames is made by telescopic rods, acting as supporting bars or tubes, and the center of mass of the device is low, close to the ground. The length and stiffness of the suspension elements is configured to be regulated according to the properties, characteristics and disability level of the individuals.

The lumbar belt can be expanded with corset and/or harness between the legs of the individual if additional support is needed because of the degree of disability of the user in order to ensure balance and body orientation within the device proposed by the invention.

The advantage of the device proposed by the invention compared with the existing systems is that top and bottom frames, comprised by the platform, are modular and transportable, the center of mass is low providing stability, the size of the platform conforms with the home usage, the size of the wheels allows negotiations of low obstacles and curb, the height of the connecting points is adjustable and controllable, and over all provides standing and walking hands free because the balance and body orientation with respect the vertical are secured with the lumbar belt and the suspension elements. Wheels can include mechanisms configured to limit the rotation about the vertical axes by means of a spring or the like, being contemplated that wheels comprise self-locking mechanism and being instrumented with brakes configured to move the device in different directions.

Suspension elements can also be of different shape, e.g. springs metal or plastic suspension system, in order to achieve the advantage of having more free space for arm movements and with a designed variable thickness of the suspension element we can design the direction of the force.

It is contemplated that the form of the bottom frame can be defined in a manner that secures that a front wheel is on the central axes of the body in the sagittal plane, and that two side wheels are behind the center of mass symmetric to the sagittal plane at a distance which guaranties that the center of mass projects in front of the center of pressure of the device when a person is using the platform. The platform can be detached to the symmetric left and right sides. Each wheel comprises a wheel supporting mechanism that is configured to support the telescopic rods acting as supporting bars of the top frame. The length of the telescopic rods can be fixed by screws with handles. The telescopic mechanism is realized with two concentric tubes, where the external tube has longitudinal gaps that when tightened does not allow the change of the length. At the top end of the telescopic mechanism is a double joint with three degrees of freedom that allows automatic positioning towards the top frame.

Thus, the device for balance and body orientation support proposed by the invention is configured to control the body position of individuals with sensory-motor disability that prevents them from normal standing and walking, wherein the dimensions of the device are selected to conform with the architectural barriers typical for home and clinical setting and standards for accessibility, wherein 90 cm is the minimal size of the door frame. The invention provides reduction of the loading of legs by partial support of the body weight; hence allows therapy of the walking in neurorehabilitation, but also exercise after surgical interventions. The device can be adjusted to fit the size of the potential individual with the use of simple tools.

In a sophisticated embodiment of the invention the device is robotized and includes external control of wheels, i.e. propulsion assist with regulated velocity and direction control, control of position of the center of mass with respect the device that is highly important for healthy-like walking and control of the tilt of the body that would facilitate the walking exercise. The envisioned invention would use sensory driven control, and possibly integrate therapeutic functional electrical stimulation or active orthotics. The invention is configured to allow clinical rehabilitation, but also home and private life use, i.e. house, street, backyard and the like.

The invention is to be used for control of balance and orientation of the trunk in humans with decreased abilities to stand and walk because of the disability of the sensory-motor systems in a manner that the special belt worn by the individual is attached to the frame by means of elastic suspensors which control the tilt and orientation with respect the frame in the zone of the body directly above the center of mass where the frame is moveable and can be disassembled, have the center of mass close to the ground, and contacts the ground at three points via wheels with direction control.

The advantage of this invention when compared with the existing systems is that the systems can be disassembled, that the center of gravity is in the lower zone, that the dimensions are adapted to fit home and outdoor environment, that the size of the wheels allows negotiation of curb and low obstacles, that allows simple regulation of the height of the system and rigidity of suspensor connections thereby limits the tilt of the trunk, that allows walking in different directions due to the directional control of the wheels, and allows standing and walking without the need to use hands for support in the free space without the risk of falling and controlled orientation of the trunk with respect the vertical.

The benefits of using the device proposed by the invention are the followings:

Early training of standing and walking. The device provides body support and postural orientation; thereby, providing many individuals with disability to begin ambulatory rehabilitation.

The device stabilizes the trunk in vertical position in the case of the stumbling or collapse of the paralyzed leg; therefore, greatly decreases the risk of fall of individuals during the walking exercise.

The device decreases the load on therapists during exercise; thereby, reduces back injuries to therapists.

The device allows longer walking sessions that allow the therapist to focus on improved walking pattern instead of concentrating on the risk of fall.

The device can be used in various environments and based on simple construction reduces costs for medical facilities.

### BRIEF DESCRIPTION OF THE DRAWINGS

For a better understanding of the described embodiments and to show more clearly how they may be carried into effect, reference will now be made, by way of example, to the accompanying drawings in which:

FIG. 1.—Shows a perspective view of the lumbar belt according to the invention.

FIG. 2.—Shows a longitudinal section of a suspension element.

FIG. 3.—Shows a perspective view of a joint element between the top frame and each telescopic rod.

FIG. 4.—Shows a perspective view of the securing mechanism comprised in each telescopic rod in order to fix the relative position of the inner and external rods.

FIG. 5.—Shows a perspective view of the platform according to the invention, comprising a top frame linked to a bottom frame by three telescopic rods, and further comprising three wheels.

FIG. 6.—Shows a perspective view of a variant embodiment of the platform represented in FIG. 5, wherein can be appreciated the lumbar belt linked to the top frame by three suspension elements.

FIG. 7.—Shows a detail, according to a perspective view, of a suspension element situated in its work position.

FIG. 8.—Shows a detail of a connecting point between the lumbar belt and a suspension element.

FIG. 9.—Shows a detail, according to a perspective view, of the front side of the bottom frame and its corresponding wheel.

FIG. 10.—Shows an schematic view corresponding to a variant of embodiment of the suspension elements.

### PREFERRED EMBODIMENT OF THE INVENTION

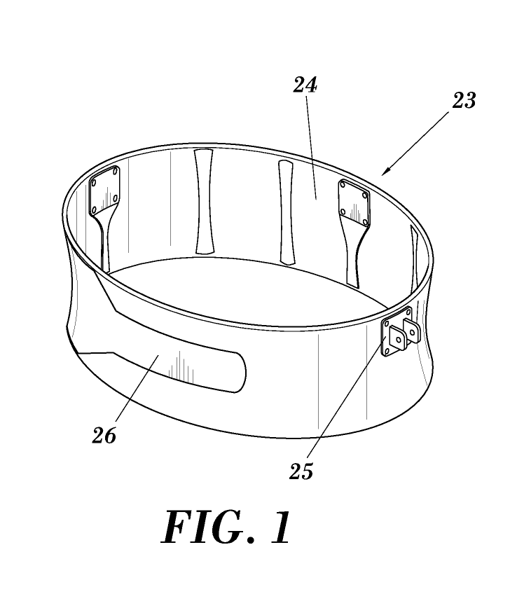

A preferred embodiment of the invention is presented in figures. The device for providing balance and body orientation to the individuals with disability comprises an ergonomic lumbar belt (23), reinforced with spring bars integrated into the lumbar belt (23) on the inner side (24) of the lumbar belt (23), where the perimeter of the lumbar belt (23) is adjustable by a broad flap (26) having quick fastening means, e.g. Velcro means or the like, as shown in FIG. 1.

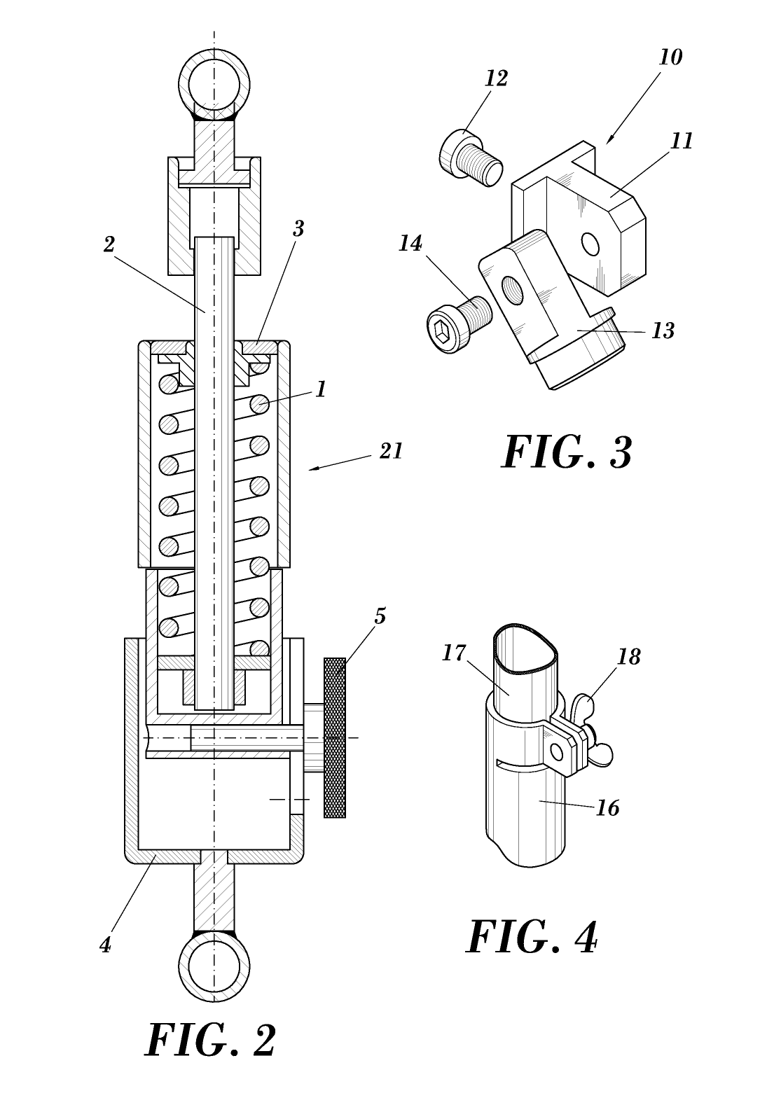

The lumbar belt (23) tightly fit the lumbar region of the individual and comprises three connecting points (25), on the outer side of the lumbar belt (23), configured to connect with suspension elements (21), i.e. suspensors shown in FIG. 2, that are adjustable in length and have adjustable stiffness allowing the positioning of the individual with respect the platform, and adjusting of the loading that the platform will absorb with respect the body weight of the individual, and adjusting of the stiffness that controls the relative movement of the center of mass and body incline towards the vertical with respect the platform. The suspension elements (21), as shown in FIG. 2, comprise springs (1) selected based on calculations of the stiffness, sliding channels (2) with limiters (3), i.e. supports of the springs (1), and external capsule (4) with a hand controlled wheel (5), acting as a screw, to lock the suspension elements (21) after adjustments.

The suspension elements (21) are connected in three points (7) to a top frame (6) of the platform composed of ergonomically designed telescopic rods (8, 9), acting as supporting bars or tubes, that hold the individual and carry three joints elements (10), one frontal telescopic rod (8) at a front side, and two lateral telescopic rods (9) at left and right lateral sides of the platform. All three telescopic rods (8, 9), comprise double joint element (10) that can be fixed in any selected position and is configures to link, in articulated manner, each telescopic rod (8, 9) with the top frame (6). The joint element (10) comprises an L element (11), that is led by the mechanism shown in FIG. 3 and screw (12) is fixed to the top frame (6) and allows adjustments by rotating around the screw (12). Other degree of freedom exists on the opposite end of the L element (11), by means of a second L element (13), where said second L element (13) connects with the upper end of the corresponding telescopic rod (8, 9) with the joint rotation axes about the axes of a second screw (14) for fixation. This construction allows the positioning of the upper top frame (6) with respect to a lower bottom frame (15) with the minimal number of supporting bars, i.e. three telescopic rods (8, 9); yet guarantying the appropriate stability and stiffness of the platform as a whole.

The bottom frame (15) has a form of an open rectangle with he dimensions determined to fit into the circle with the diameter of 90 cm; yet large enough to allow entry from the back side with a wheelchair. The top frame (6) has a minimum height of 10 cm and a form of an open rectangle that allows the individual when standing from a sitting position to enter into the platform.

The setting of the height of the platform is designed by a securing mechanism (18) configured to secure the length of the telescopic rods (8, 9), as shown in FIG. 4, where the fixation is provided by tightening of the perimeter of an external rod (16) around an inner rod (17), comprised by each telescopic rod (8, 9), after screwing of a screw with a nut comprised by the securing mechanism (18). The inner rod (17) and the external rod (16) can rotate one with respect the other providing the necessary degree of freedom of the platform as a whole.

According to a preferred embodiment of the invention, the three telescopic rods (8, 9) have adjustable length between 50 and 130 cm, providing rigid connection between the bottom frame (15) and top frame (6) by means of joint elements (10)

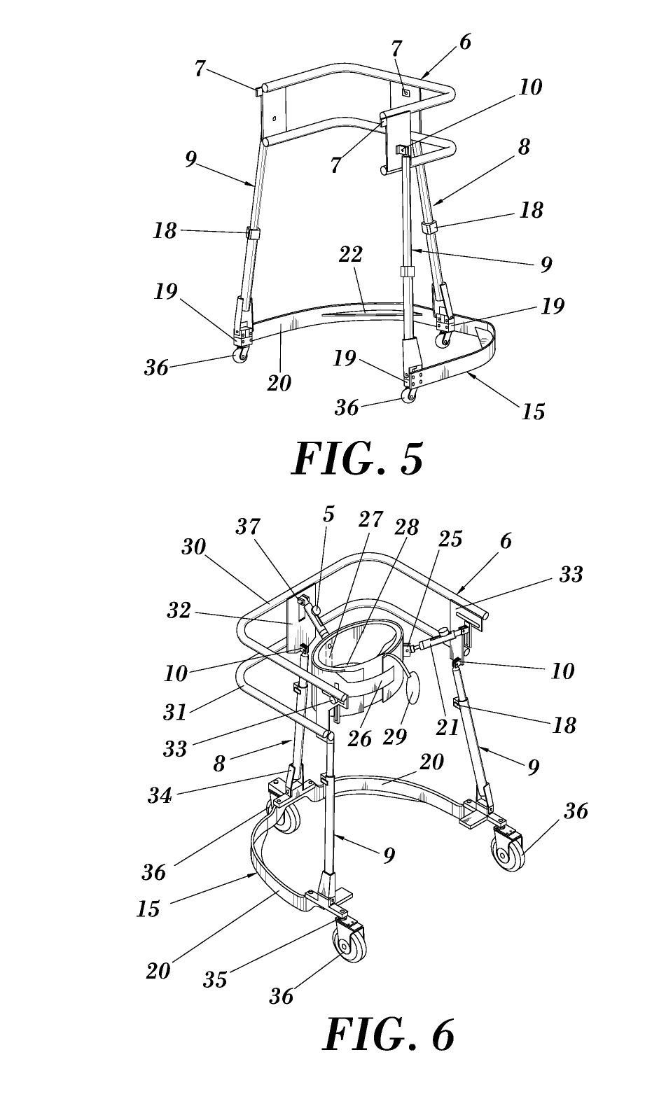

Telescopic rods (8, 9) in the zone of the bottom frame (15) are articulated to three wheel supporting mechanisms (19). The bottom frame (15) is designed by two symmetric massive metal profiles (20) securing that the center of mass of the platform is close to the ground securing from tipping of the system when individual is supported by the platform. The massive profiles (20) are designed in manner that allows detaching, but also include space for additional weight (22) when this becomes necessary for taller and higher individuals for increased safety and stability of the platform. Each wheel supporting mechanisms (19), shown in FIG. 5, have in the middle a hole for the connection to a wheel fork that connects with the axial bearing and secured with a screw and support.

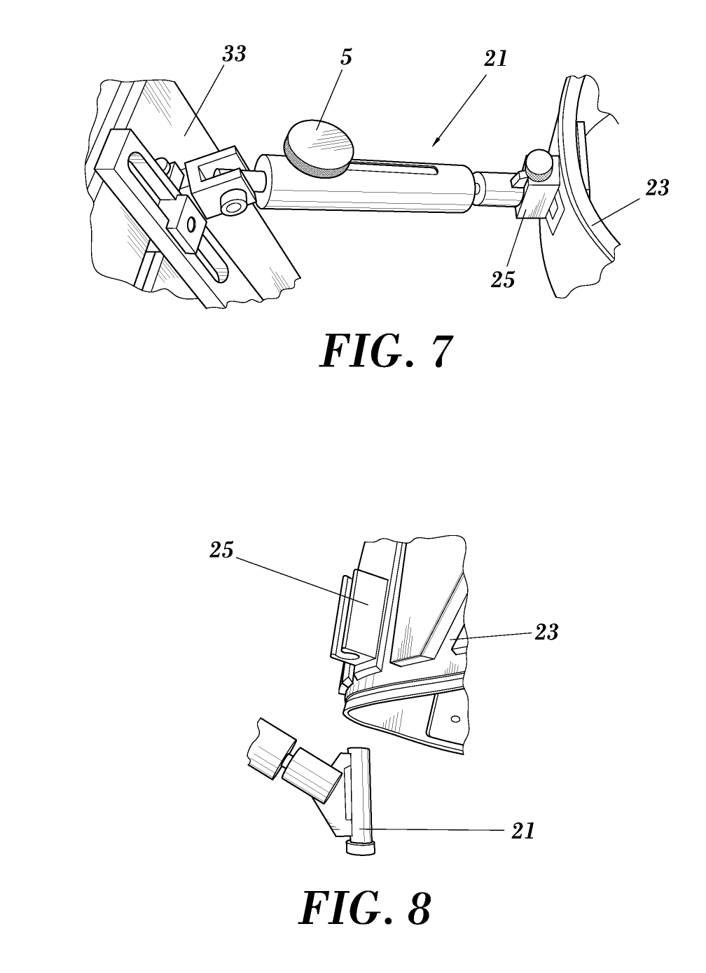

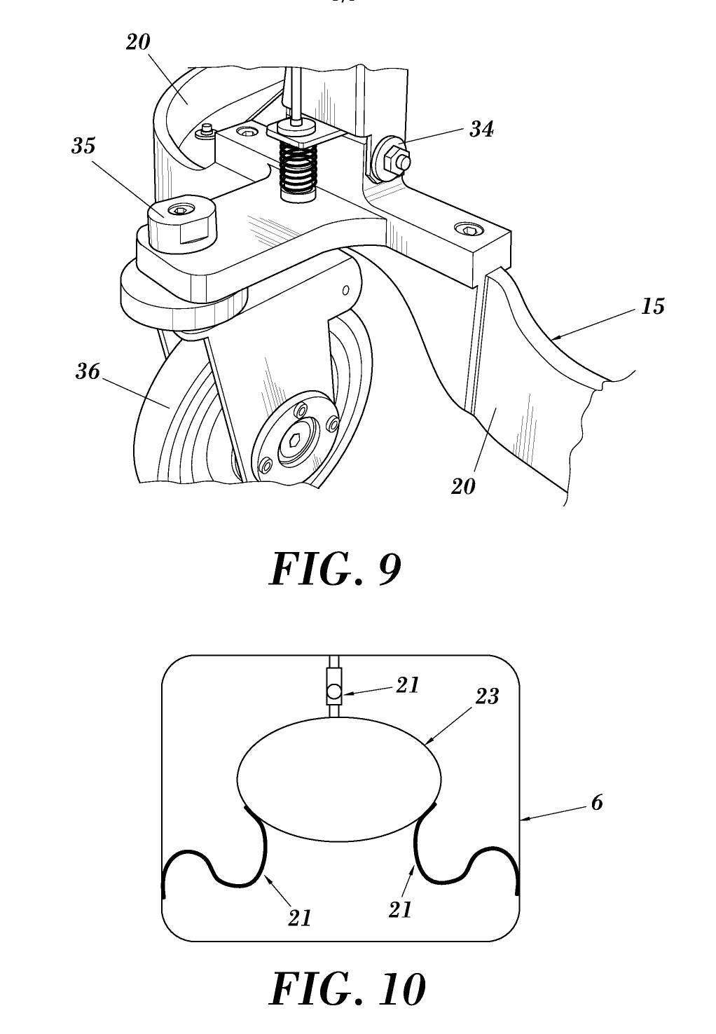

According to a variant embodiment of the invention, shown in FIGS. 6 to 9, the bottom frame (15) is defined in a manner where the front central wheel (36) in the central sagittal plane of the user and comprises free rotation around the vertical axes, is connected by two horizontal profiles (20) which at the ends have one wheel (36) each.

The wheel supporting mechanisms (19) are used as the lower connection points of the adjustable telescopic rods (8, 9) that can be fixed at desired length by means of securing mechanisms (18) consisting of hand controlled brackets and locking mechanism based on a clamp and the adjusting screw. The telescopic effects are realized by use of two concentric tubes (16, 17) of two matching diameters and the fixation of the length is by a special bracket with the screw and locking handle.

On the top end of the telescopic rods (8, 9) is a double joint element (10) which allows full adjustability of the angle between the supporting rods (8, 9) to the top frame (6), where the fixation of the angle is done by screw mechanisms (12, 14).

According to the above referred variant of embodiment of the invention, shown in FIGS. 6 to 9, the device comprises a two-layer ergonomic lumbar belt (23) with the external layer strengthened with three axial plastic bars (27) integrated into the external belt, and internal layer comprises air chambers (28) and a pump (29) for good fit to the body contours that can be adjusted in length to match the perimeter of the waist and trunk of the user by means of a flap (26) with fastening means consisting of Velcro, wherein the lumbar belt (23) has three connecting points (25) consisting of hinge joints parallel to the vertical line for connecting to the suspension elements (21) having adjustable stiffness and fixing the orientation of the external belt with respect the vertical line.

The top frame (6) comprises an upper tube (30) linked to a lower tube (31) by means of a frontal connecting plate (32) and two lateral connecting plates (33). The suspension elements (21), connected to the connecting points (25), allows adjusting of the stiffness between the body and the top frame (6) with the special joints allowing vertical and horizontal positioning of the ends of suspension elements (21) with hinge joints within the lateral connecting plates (33) and vertical positioning at the frontal connecting plate (32) with the joint.

The two metal profiles (20) that compose the bottom frame (15) are connected by a frontal hinge joint (34) having the horizontal axes to three identical telescopic rods (8, 9) that connects to the top frame (6) with the joint elements (10) consisting of hinges.

Suspension elements (21) are connected to the top frame (6) with adjustable joints connected to the connecting plates (32, 33), and connected to the lumbar belt (23) with the connecting points (25).

FIG. 10 shows a variant of embodiment corresponding to the suspension elements (21) that consists of a springs suspension system, thus achieving the advantage of having more free space for arm movements and with a designed variable thickness of the suspension element we can design the direction of the force.

The bottom frame (15) has three vertical rotational joints (35) at front central sagittal plane of the device, and at both rear ends of the profiles (20). These vertical rotational joints (35) are configured to allow controlled rotation around the vertical axes of the wheels (36), thereby maneuverability of the device when walking. The rear wheels (36) are instrumented with a pad braking mechanisms (37). Even though is not represented, but it is contemplated that only the frontal wheel (36) comprises a vertical rotational joint (35) remaining both rear wheels (36) in a fixed position.

Although this invention has been shown and described with respect to exemplary embodiments thereof, it should be understood by those skilled in the art that the foregoing and various other changes, omissions, and additions in the form and detail thereof may be made therein without departing from the spirit and scope of the invention. Accordingly, the present invention has been described in several embodiments by way of illustration rather than limitation.

1. Device for balance and body orientation support, for control of balance and orientation of the body in humans with decreased ability to stand and walk hands free, comprising:
a top and a bottom frame,
a suspension system including three suspension elements each having a first and a second end,
a lumbar belt configured to interface the individual, wherein the lumbar belt is articulated in three top frame connecting points via first ends of said suspension elements to the top frame, said lumbar belt comprising three lumbar belt connecting points connected with second ends of said suspension elements,
where said top frame is connected with the bottom frame that interfaces the ground by three wheels configured to allow motion of a platform defined by both frames and the wheels in a horizontal plane,
where the connection between the bottom frame and the top frame is made by telescopic rods and the center of mass of the device is close to the ground,
wherein each suspension element comprises an external capsule, an internal capsule, a spring disposed within the internal capsule and a longitudinal rod supported by the internal capsule for telescopic movement against a force of the spring,
wherein a length of each of the suspension elements is configured to be regulated by movement of the external capsule relative to the internal capsule according to properties, characteristics and disability level of each individual, whereby adjusting of stiffness of the suspension system between the lumbar belt and the top frame that controls relative movement of the center of mass and body incline towards with respect the platform is achieved.

2. Device for balance and body orientation support, according to claim 1, wherein the bottom frame is configured to secure that a front wheel is on central axes of a body of a user in a sagittal plane, and two side wheels are behind the center of mass symmetric to the sagittal plane at a distance which guaranties that the center of mass projects in front of a center of pressure of the device when an individual is using the platform.

3. Device for balance and body orientation support, according to claim 1, wherein a length of each telescopic rod can be fixed by a securing mechanism.

4. Device for balance and body orientation support, according to claim 1, wherein a top end of each telescopic rod is connected, in an articulated manner, to the top frame via a joint element with three degrees of freedom configured to allow automatic positioning of the top frame.

5. Device for balance and body orientation support, according to claim 1, wherein the lumbar belt is reinforced with spring bars integrated into the lumbar belt, where a perimeter of the lumbar belt is adjustable by a flap having quick fastening means.

6. Device for balance and body orientation support, according to claim 1, wherein the bottom frame comprises two symmetric massive profiles configured to such that the center of mass of the device is close to the ground, wherein the massive profiles are configured to allow detaching.

7. Device for balance and body orientation support, according to claim 1, wherein the lumbar belt is strengthened with three axial bars integrated into the lumbar belt, and an internal layer of the lumbar belt comprises air chambers and a pump for good fit to a user's body contours.

8. Device for balance and body orientation support, according to claim 1, wherein the top frame comprises a frontal connecting plate and two lateral connecting plates, wherein the damped springs mechanisms are configured to allow adjusting of a stiffness between the body and the top frame comprising special joints allowing vertical and horizontal positioning of the ends of damped springs mechanisms.

9. Device for balance and body orientation support, according to claim 1, wherein the bottom frame has three vertical rotational joints at front central sagittal plane of the device, and at both rear ends of the profiles, being configured said vertical rotational joints to allow controlled rotation around vertical axes of the wheels, thereby providing maneuverability of the device when walking.
